(19) United States
(12) Patent Application Publication
(10) Pub. No.: US 2002/0130219 A1
(43) Pub. Date: Sep. 19, 2002

(54) System for restraining aircraft delivery carts

(76) Inventors: Van R. Parseghian, La Jolla, CA (US); Michiko Isagawa, La Jolla, CA (US); Winthrop D. Childers, San Diego, CA (US)

Correspondence Address: Van R. Parseghian, 1442 Sandal Lane, La Jolla, CA, 92037, US

(21) Appl. No.: 09/812,286

(22) Filed: Mar. 19, 2001

(51) Int. Cl. B64D 11/06; B64D 13/00

(52) U.S. Cl. 244/118.6

(57) ABSTRACT

A restraining system is provided for a delivery cart for delivering articles such as food and beverages on board an aircraft. The aircraft includes an aisle for providing access by the delivery cart to rows of seats adjacent to the aisle. The restraining system includes a track positioned along the aisle and a restraining apparatus that is mounted to the delivery cart. The restraining apparatus engages the track to prevent the food and beverage cart from lifting when the aircraft encounters sudden drops and/or unexpected turbulence.

### THE FIELD OF THE INVENTION

The present invention relates generally to aircraft safety, and more particularly to preventing injuries related to delivery carts.

### BACKGROUND OF THE INVENTION

Most commercial airlines provide food and beverage service to their customers during flights. During a particular flight, the customers are seated in rows of seats of a plane that are adjacent to an aisle. At some point, a flight attendant typically rolls a cart such as a food and beverage cart (or a cart containing other articles such as headsets or duty free items) from the galley to aisle.

A problem occurs when the air around the plane becomes particularly turbulent. If the air is turbulent enough the cart can fall over or become like a projectile, striking flight attendants and/or seated passengers. Even apparently clear surrounding air can exert sudden severe turbulence on an aircraft, causing a cart to become temporarily airborne. A number of these incidents have been documented by the FAA.

One solution to the problem is to keep the cart stowed away during periods of possible turbulence. Unfortunately, this would create a significant inconvenience for the passengers, since there would be many situations where the onset of turbulence is not predictable. Currently, due to the unpredictability of turbulence, the only practical solution seems to be to accept a certain risk of possible cart-related injuries.

What is needed is a solution to eliminate such cart related risk while still allowing for the convenient delivery of articles to passengers. Issues to consider include the cost and complexity of the solution, ease of use of the solution, the impact the solution may have on weight of the aircraft, and finally the existence of equipment such as existing aircraft and carts that do not have the solution.

### SUMMARY OF THE INVENTION

A restraining system is provided for a delivery cart for delivering articles such as food and beverages on board an aircraft. The aircraft includes an aisle for providing access by the delivery cart to rows of seats adjacent to the aisle. The restraining system includes a track positioned along the aisle and a restraining apparatus that is mounted to the delivery cart. The restraining apparatus engages the track to prevent the food and beverage cart from lifting when the aircraft encounters sudden drops and/or unexpected turbulence.

### BRIEF DESCRIPTION OF THE DRAWINGS

FIGS. 1A, 1B, and 1C depict plan, side, and front schematic views, respectively of the preferred embodiment of the invention. Left off are delivery cart details such as slots for receiving food trays, etc., that are in common use with food and beverage delivery carts.

FIGS. 2A, 2B-1, 2B-2, and 2C are schematic representations of a first embodiment of the invention. FIG. 2A is closeup of a section of track 120 that is from a first embodiment of track 20 from FIG. 1A. FIGS. 2B-1 and 2B-2 are cross-sectional representations of a first embodiment of the invention taken from section line AA′ of FIG. 1A. FIG. 2C is a side view of one embodiment of cart 12 utilizing the invention of FIGS. 2A, 2B-1, and 2B-2.

FIGS. 3A-3C are cross sectional representations of a second embodiment of the invention taken from section line AA′ of FIG. 1A.

FIG. 4 depicts a side view of a delivery cart of the present invention utilizing a third embodiment of the invention.

FIG. 5 depicts a cross sectional representation of a fourth embodiment of the invention taken from section line AA′ of FIG. 1A.

FIG. 6 depicts a side view of a delivery cart of the present invention utilizing a fifth embodiment of the invention.

FIG. 7 is a cross sectional representation of a sixth embodiment of the invention taken from section line AA′ of FIG. 1A.

FIG. 8 is a flow chart representation of the method of retrofitting an aircraft with the present invention.

FIG. 9 is a flow chart representation of the method of using the present invention on board an aircraft.

### DESCRIPTION OF THE PREFERRED EMBODIMENTS

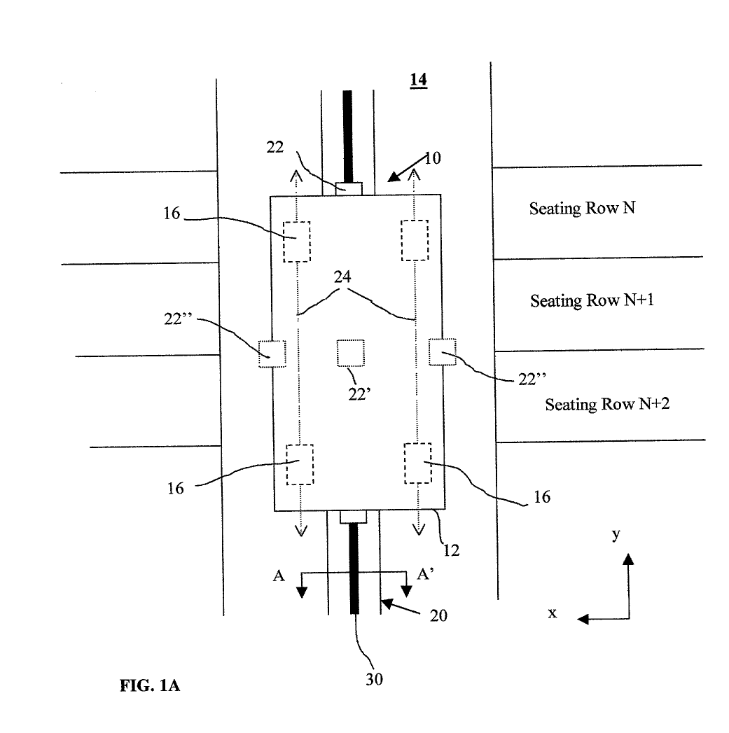

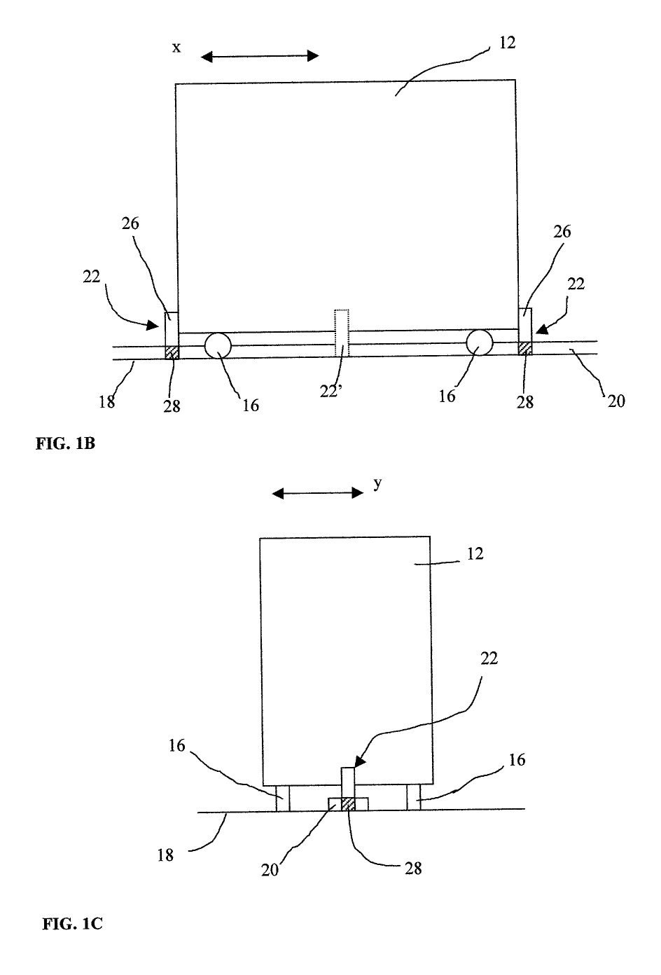

FIGS. 1A-C depict an embodiment of a retrofit restraining system 10 of the present invention. Retrofit restraining system 10 is utilized to restrain a cart 12 when cart 12 is being moved down an aisle 14 of an aircraft while delivering articles such as food and beverages to passengers seated in rows of seats N, N+1, etc. Cart 12 includes a plurality of wheels 16 that roll along a floor 18 of aisle 14 along a transit axis x. Restraining system 10 includes a track 20 that is mounted securely to floor 18 and a restraining apparatus 22 that engages the track 20 to restrain cart 12 from lifting vertically or moving sideways during sudden downward and/or sideways accelerations of the aircraft such as those accelerations caused by air turbulence.

Track 20 can be formed directly into the floor 18 or it can be a separately mounted track 20 that is attached to the floor 18 by any of a number of means, including adhesives, rivets, screws, welding, etc. Track 20 is preferably a single track to minimize cost and complexity of restraining system 10. Retrofit restraining system 10 is preferably arranged so that track 20 is positioned between the trajectory 24 of wheels 16 (See FIG. 1) as measured along a transverse axis y that is transverse or perpendicular to transit axis x. By positioning track 20 between the wheels' trajectory 24, the stability of cart 12 is improved. Preferably, track 20 would be positioned at the midpoint between the trajectories 24 of the wheels 16 with respect to the transverse axis y.

Restraining apparatus 22 includes an attachment portion 26 for securing the restraining apparatus 22 to cart 12, and an engagement portion 28 for engaging track 20 to vertically restrain motion of cart 12. Preferably, restraining apparatus 22 includes two restraining apparatus 22 located at the leading and trailing ends of the cart 12 relative to the transit axis x. However, an alternative location for a restraining apparatus 22 would be near a middle portion of cart 12 relative to the transit axis x, as indicated by 22′ for a restraining apparatus near the center of the cart and 22″ for a restraining apparatus for engaging dual tracks (not shown). Preferably restraining apparatus 22 is spaced away from wheels 16 to allow for a location that enables ease of retrofitting existing carts. Preferably restraining system 10 is not designed so as to require that wheels 16 align with track(s) 20, as the precise alignment and added complexity of the resultant system would add cost to retrofit system 10.

In one enhanced version of cart 12, wheels 16 include damping elements or other devices that have the effect of restraining the speed at which wheels 16 can spin. Such damping elements are known, and tend to exert a torque on wheels 16 that opposes the motion of wheels 16 and increases rapidly as the spin speed of the wheels increases. This would prevent a cart from rolling along track 20 in an uncontrolled manner while still allowing the cart to be easily rolled along aisle 14. Thus, for such an enhanced version of cart 12, uncontrolled vertical and horizontal motion of cart 12 is maintained.

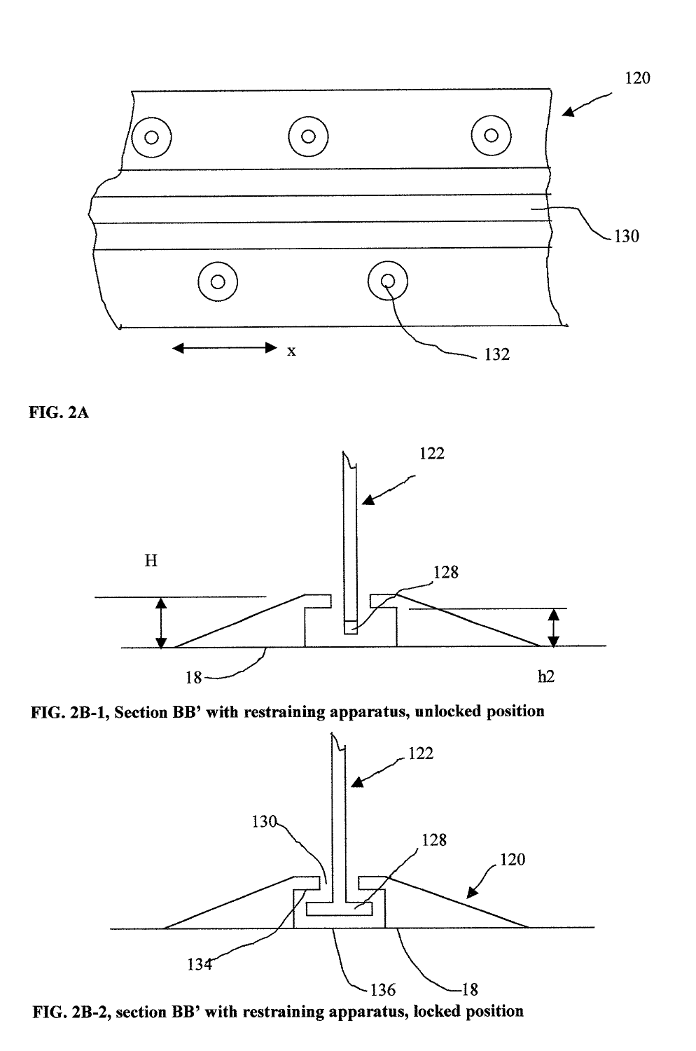

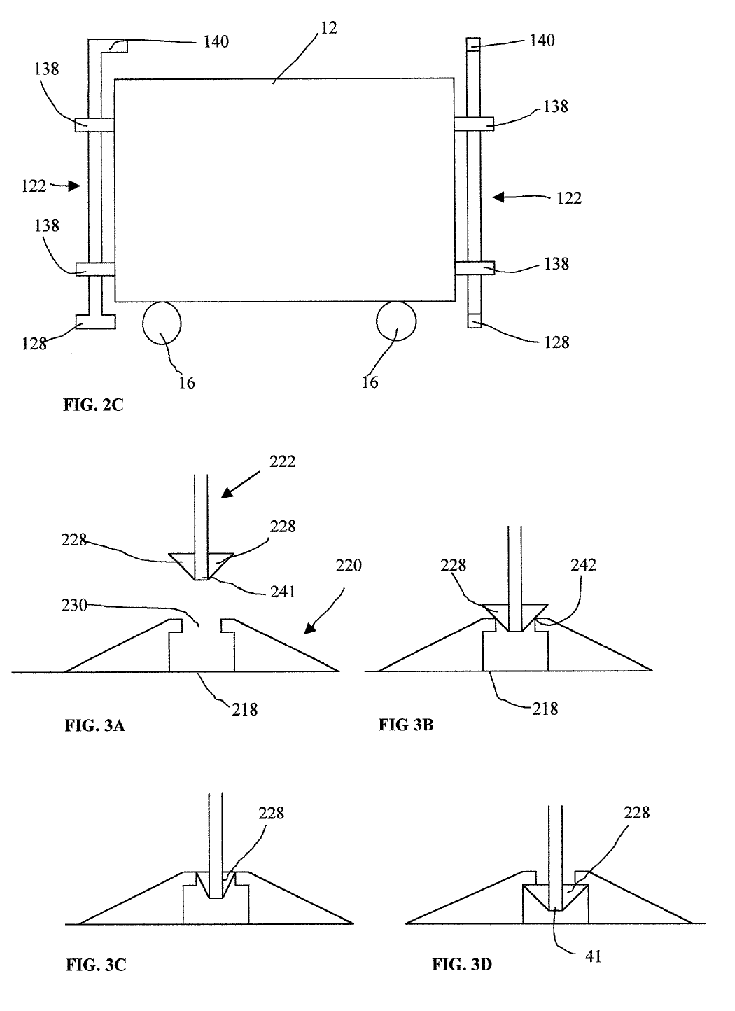

FIGS. 2A-2C illustrate a first particular embodiment of the retrofit system 10 illustrated in FIG. 1. FIG. 2A illustrates a portion of track 120 (that is a first embodiment of track 20) that includes a slot 130 aligned with transit axis x (the axis along which the cart moves as articles are provided to passengers) for receiving the engagement portion 128 of restraining apparatus 122 (that is a first embodiment of restraining apparatus 22 of FIGS. 1A-C). Track 120 also includes openings 132 for mechanically fastening track 120 to floor 18.

FIGS. 2B-1 and 2B-2 depict a cross sectional representation taken from AA′ of FIG. 1A along with a broken off representation of restraining apparatus 122 in a “unlocked” and “locked” state, respectively. Track 120 has a beveled profile to minimize the tendency for a person walking down aisle 14 to trip or stumble on track 120. Preferably an overall height H of track 120 above floor 18 would be approximately less than or equal to a height of carpeting on the floor 18 for the same reason. FIG. 2B-1 indicates an “unlocked” state of restraining apparatus 122 such that engagement portion 128 can be lifted out of slot 130 without mechanical interference. FIG. 2B-2 indicates a “locked” state of restraining apparatus 122, such that engagement portion 128 will engage engagement surface 134 of track 120, preventing restraining apparatus 122 from being vertically lifted from track 120. Preferably track 120 is formed from a wear resistant material such as an aluminum alloy or steel, although high strength polymer materials may also be suitable.

Restraining apparatus 122 would normally be in the “locked” state when cart 12 is in transit along aisle 14 for the purpose of delivering food, beverages, and other articles to passengers seated in rows of seats adjacent to aisle 14. To prevent engagement portion 128 from “binding” or “getting stuck” in track 120 in a way that would impede motion of cart 12 along aisle 14, a vertical dimension h1 of engagement portion 128 (the diameter of engagement portion 128 if engagement portion 128 is cylindrical in shape) is less than a vertical distance h2 between engagement surface 134 and a lower surface 136. In the illustrated embodiment, lower surface 136 is the aisle floor 18. Preferably, the vertical distance h2 between engagement surface 134 and lower surface 136 exceeds the vertical dimension h1 of engagement portion 128 to allow for the existence of food particles and other contamination that might tend to accumulate in track 120. Also, it is advantageous to select materials for the outer surface of engagement portion 128 to minimize friction between engagement portion 128 and engagement surface 134 or between engagement portion 128 and lower surface 136. One way to do this is to coat engagement portion 128 with a low friction material such as a fluoropolymer or a diamond like coating. Finally, engagement portion 128 may be turnably or rotatably mounted to restraining apparatus 122 to further reduce the possibility of binding of engagement portion 128 in track 120.

Turning to FIG. 2c, cart 12 is depicted with a particular embodiment of two restraining apparatus 122 mounted thereon. Each restraining apparatus 122 is rotateably mounted to cart 12 via bracket 138. Bracket 138 also allows limited rotational and vertical motion of restraining apparatus 122 to allow restraining apparatus 122 to be engaged (locked) or disengaged (unlocked) from track 120. Each restraining apparatus 122 includes a handle 140 for locking and unlocking each restraining apparatus 122.

The restraining apparatus 122 on the left side of FIG. 2c is depicted to be in the unlocked position, with the engagement portion 128 aligned with the slot 130 in track 120 to allow vertical insertion and removal of engagement portion 128 from slot 130. To provide restraint, the restraining apparatus 122 is lowered by sliding it through the brackets 138 until the engagement portion is received into slot 130. Then, handle 140 is turned so as to align engagement portion 128 with transverse axis y so that it is perpendicular to slot 130. When engagement portion 128 is perpendicular to slot 130, it is in the locked position, securing the cart 12 from lifting from floor 14.

FIGS. 3A-3D depict a cross section representation of a second embodiment of the present invention taken from section lines AA′ of FIG. 1A including a second embodiment of restraining apparatus 22 referred to in this embodiment as element 222. In this second embodiment, engagement portion 228 is a pair of spring loaded engagement features 228 that are initially expanded under spring loading, as depicted in FIG. 3A. Each of the pair of spring loaded engagement features can be displaced relative to a leading end 241 of restraining apparatus 222. As the leading end 241 of restraining apparatus 222 is inserted into slot 230, the spring loaded engagement features 228 engage edges 242 of slot 230 as depicted by FIG. 3B. The spring loaded engagement features 228 are displaced relative to leading end 241 and hence partially collapse as restraining apparatus 222 is further installed into slot 230, as depicted by FIG. 3C. As depicted in FIG. 3D, fill insertion causes the spring loaded engagement features 228 to re-expand, locking leading end 241 into slot 230. To remove restraining apparatus 222 from slot 230, restraining apparatus 222 can be twisted to align the engagement features 228 with slot 230 in a manner similar to that as depicted in the first embodiment with respect to FIGS. 2B-C to unlock the engagement features from track 220. Alternatively, restraining apparatus 222 can contain an internal mechanism for collapsing engagement features 228.

FIG. 4 depicts a side view of cart 12 utilizing a third embodiment of restraining system 10, for restraining cart 12 from lifting vertically from floor 18. In this embodiment, restraining apparatus 322 includes a restraining apparatus 322 mounted at each end of cart 12. In a preferred embodiment, each restraining apparatus 322 would include a spring loaded engagement portion such as the engagement portion 228 discussed with respect to FIGS. 3A-3D. Restraining apparatus 322 is depicted in FIG. 4 as having a locked position, as indicated by 322-L wherein restraining apparatus is slidably coupled to track 320. Restraining apparatus 322 is depicted as having an unlocked position, as indicated by 322-U. Restraining apparatus 322 is lowered to track 320 and/or coupled or locked to track 320 by placing a downward force on footpedal 340. This design provides a very convenient way of coupling restraining apparatus 322 to track 320. Restraining apparatus can be disengaged in any number of ways which are evident depending on the choice of engagement portion 328 that is chosen.

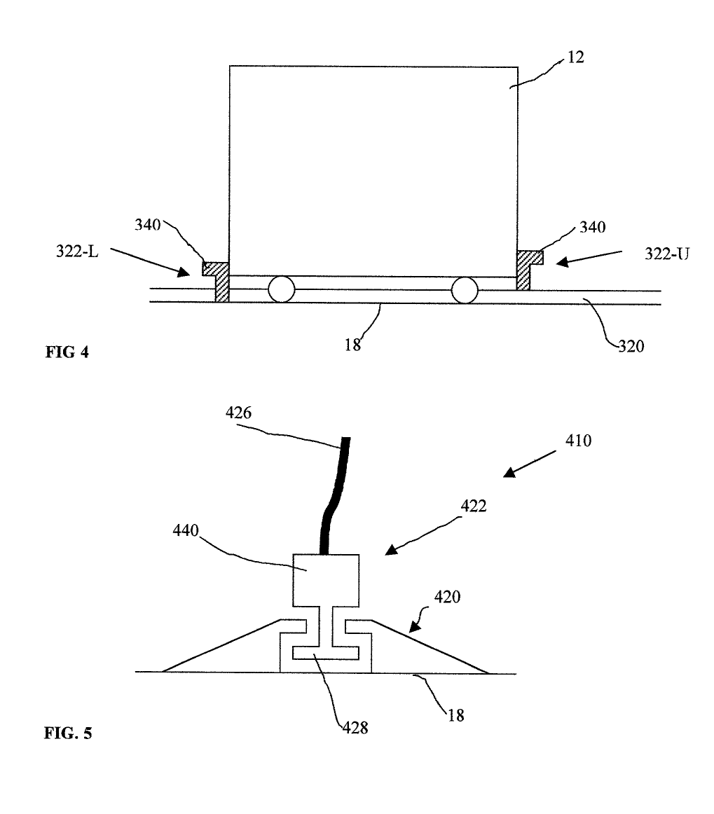

FIG. 5 depicts a cross-sectional representation of a fourth embodiment of the restraining system 10 of the present invention taken through section lines AA′ of FIG. 1A and referred to as element 410. Restraining apparatus 422 includes a flexible attachment portion 426, such as a chain or cable 426 that attaches at a first end to a lower portion of a leading or trailing end of cart 12 and at a second end to handle 440. Handle 440 is rigidly coupled to engagement portion 428. To unlock restraining apparatus 422 from track 420, the handle 440 is twisted to allow engagement portion 428 to be removed from slot 430 of track 420. Functionally, the unlocked and locked positions of this fourth embodiment are thus similar to the first embodiment depicted with respect to FIGS. 2B-1 and 2B-2, respectively.

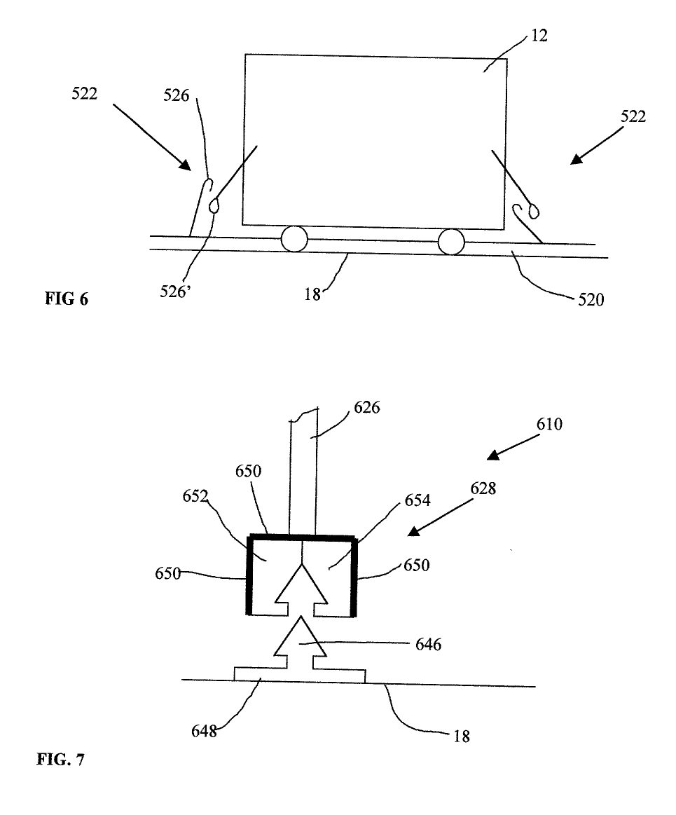

FIG. 6 depicts a side view of cart 12 utilizing a fifth embodiment of the system 10 of the present invention. In this embodiment, cart 12 is vertically secured to aisle floor 18 via a flexible restraining apparatus 522. Restraining apparatus 522 includes a pair of cables 522 at each end of cart 12. One of the pair of cables 522 is slidably secured to track 520 at a first end and has a first fastening device 526 at the other end. The second of the pair of cables 522 is fastened to cart 512 at a first end and has a complementary second fastening device 526′ that allows ease of coupling the first and second fastening devices. For example, the first fastening device 526 can be a spring clip and the second fastening device 526′ can be a loop formed in a cable. In particular embodiments, cables 522 can be coupled to track 520 with an engagement portion (not shown) that is similar to that discussed with respect to FIGS. 2, 3, 5, or 7.

FIG. 7 depicts a cross-sectional representation of a sixth embodiment of the system 10 of the present invention taken through section AA′ of FIG. 1A. In this sixth embodiment, track 620 has a central engagement rail 646 that protrudes above a support base 648. Restraining apparatus 622 includes an engagement portion 628 that surrounds and latches over engagement rail 646 when engagement portion 628 is lowered onto track 620. A leaf spring 650 provides a clamp force of engagement portion 628 around central rail 646. Engagement portion 628 is constructed of two features or leaves 652 and 654 that swing apart and are displaced when engagement apparatus 628 is pressed over central rail 646 to allow central rail 646 to open and latch over central rail 646.

As can be seen, there are number of different options for engagement apparatus 22 and track 20, as well as the way in which restraining portion 22 is mounted to cart 12. Some of these different options are depicted and discussed with respect to FIGS. 2-7, although different implementations and combinations of features are possible within the scope of the invention. Each of these embodiments enable a simple, low weight and low cost way of retrofitting an aircraft with restraining system 10 to vertically restrain cart 12 during sudden turbulence.

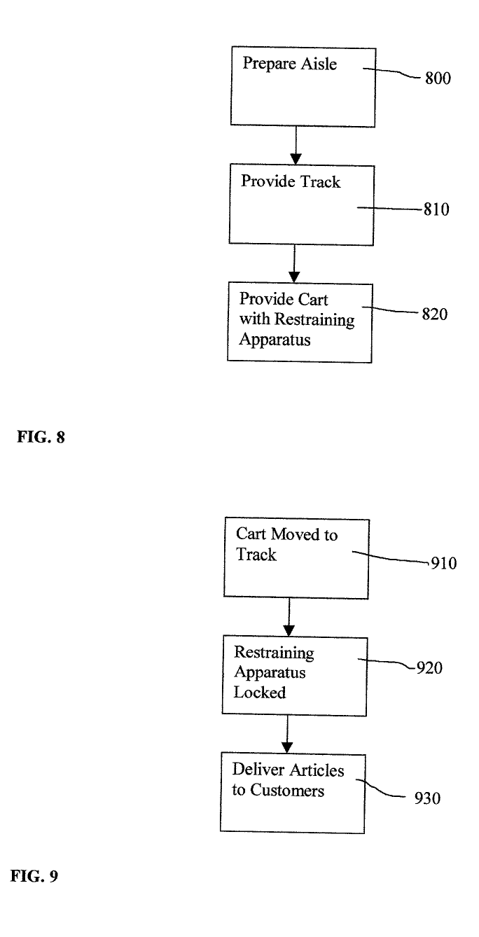

The present invention can be installed onto a commercial aircraft according to a process that is depicted in flowchart form with respect to FIG. 8. First, as indicated by step 800, the aisle is prepared for installation of the restraining system 10. Preferably, any existing carpeting is removed from aisle floor 18. Second, as indicated by step 810, track 20 is secured on aisle floor 14. This can be done via an adhesive, mechanical fastening devices such as screws or rivets, or with conventional methods. Track 20 is preferably a single track (rather than two tracks) to minimize cost, complexity of installation, and weight of the restraining system 10. Third, as indicated by step 830, a cart 12 is provided having restraining apparatus 22. Preferably, the restraining apparatus 22 is spaced apart from wheels 16 to allow for ease of retrofitting pre-existing carts 12.

The present invention is utilized for delivery of articles to passengers according to a process as illustrated with respect to FIG. 9. First, as indicated by step 900, cart 12 is moved into position for being rolled along aisle floor 18. Next, as indicated by step 910, the restraining apparatus 22 is mechanically coupled with track 20. As stated before, preferably track 20 is a single track to minimize the difficulty in coupling restraining apparatus to track 20. In a preferred embodiment, engagement feature 22 is placed into a locked position, as would be the case with any of the embodiments depicted by FIGS. 2-7. Finally, as indicated by step 920, articles such as food and beverages are delivered along the aisle 14 to customers while engagement portion 28 provides continuous vertical restraint for cart 12. By having a single track 20, the possibility of having binding between restraining apparatus 22 and engagement portion 28 is reduced, and the difficulty of disengaging restraining apparatus 22 and track 20 is also reduced.

What we claim is:

1. An aircraft having a retrofit restraining system for restraining a food and beverage cart, the food and beverage cart having a plurality of wheels, comprising:
an aircraft aisle for providing access to rows of seats; and
a single track that is positioned along the aisle, the single track positioned to allow the plurality of wheels to roll down the aisle on either side of the single track as the food and beverage cart is moved down the aisle.

2. The aircraft of claim 1, wherein the single track is positioned approximately along the center of the aisle.

3. The aircraft of claim 2, wherein the track is a separately attached track that rises above the floor of the aisle.

4. The aircraft of claim 1, further comprising a food and beverage cart including a restraining apparatus, the restraining apparatus engages the track to restrain motion of the cart during sudden aircraft accelerations.

5. The system as in claim 4, wherein the restraining apparatus includes two restraining apparatus.

6. The system as in claim 5, wherein the two restraining apparatus are adjacent to leading and trailing ends of the cart relative to the direction of transit of the cart.

7. The system as in claim 4, wherein the track has an engagement surface and wherein the restraining apparatus includes an engagement portion that engages the engagement surface during sudden vertical drops of the aircraft to restrain the cart from lifting.

8. The system as in claim 7, further comprising a lower surface positioned below the engagement surface by a distance h2, and wherein the engagement portion has a vertical dimension h1, and wherein h2 exceeds h1 by an amount that allows the track to accommodate particles such as food particles.

9. The system as in claim 4, further comprising a foot pedal positioned at a lower portion of the cart, the foot pedal is utilized to lower the restraining apparatus and to couple the restraining apparatus to the track.

10. The system as in claim 4, wherein the restraining apparatus includes plurality of cables for coupling the cart to the track.

11. The system as in claim 4, wherein the restraining apparatus includes a spring loaded engagement feature that is displaced and couples to the track when a lower end of the restraining apparatus is lowered into engagement with the track.

12. A system for providing articles to passengers seated on an aircraft, the aircraft having rows of seats adjacent to an aisle, comprising:
a track that is positioned along the aisle; and
a cart that traverses the aisle and is supported upwardly by a plurality of wheels, the cart including a restraining apparatus that engages the track at a location spaced from any of the plurality of wheels to restrain motion of the cart during sudden aircraft accelerations.

13. The system as in claim 12, wherein the track is a retrofit track that has been provided on a pre-existing floor of the aircraft.

14. The system as in claim 12, wherein the cart was previously manufactured without the restraining apparatus and the restraining apparatus is an added retrofit restraining apparatus.

15. The system as in claim 12, wherein the restraining apparatus is two restraining apparatus.

16. The system as in claim 12, wherein the two restraining apparatus are adjacent to leading and trailing ends of the cart relative to the transit direction of the cart.

17. The system as in claim 12, wherein the track has an engagement surface and wherein the restraining portion includes an engagement portion that engages the engagement surface during sudden acceleration of the aircraft to restrain motion of the cart.

18. The system as in claim 17, further comprising a lower surface positioned below the engagement surface by a distance h2, and wherein the engagement portion has a vertical dimension h1, and wherein h2 exceeds h1 by an amount that allows the track to accommodate particles such as food particles.

19. The system as in claim 12, wherein the track is a single track that is positioned to allow the plurality of wheels to roll down the aisle on either side of the single track as the food and beverage cart is moved down the aisle.

20. A method of delivering articles to passengers seated in rows that are adjacent to an aisle on an aircraft, comprising:
providing a cart having a restraining apparatus, the cart having a plurality of wheels;
providing a single track that is positioned along the aisle;
positioning the cart over the track such that the plurality of wheels are positioned on either side of the track; and
coupling the restraining apparatus to the track to provide restraint of the cart during sudden aircraft accelerations.

21. The method of claim 20, wherein the restraining apparatus includes a foot pedal, and wherein coupling the restraining apparatus to the track includes applying a downward force to the foot pedal to move the restraining apparatus into engagement with the track.

22. The method of claim 20, wherein the restraining apparatus includes a cable and an engagement portion, and wherein coupling the restraining apparatus to the track includes coupling the engagement portion to the track.

23. The method of claim 20, wherein the restraining apparatus includes a pair of cables, and wherein coupling the restraining apparatus to the track includes coupling the pair of cables together.

24. The method of claim 20, wherein the restraining apparatus includes an engagement portion having a spring loaded engagement feature and wherein coupling the restraining apparatus to the track includes displacing the spring loaded engagement feature.

25. The method of claim 20, wherein the restraining track has a central slot, and wherein the restraining apparatus has an engagement portion, and wherein the coupling the restraining apparatus to the track includes: inserting the engagement portion into the slot and moving the engagement portion from an unlocked to a locked position.

26. The method of claim 20, further comprising: rolling the cart along the aisle while the restraining apparatus is continuously coupled to the track.

27. A retrofitting device for retrofitting a delivery cart having a plurality of wheels, the delivery cart for providing articles to passengers seated on an aircraft, the aircraft having rows of seats adjacent to an aisle providing access to the seats, the retrofitting device comprising:
an attachment portion for attaching the retrofitting device to the cart; and
an engagement portion for coupling to a track on the floor of the aisle to provide restraint of the delivery cart during aircraft accelerations.

28. The retrofitting device of claim 27, wherein engagement portion includes a spring loaded engagement feature.

29. The retrofitting device of claim 27, wherein the retrofitting device further comprises a cable segment.

30. The retrofitting device of claim 27, wherein the retrofitting device further comprises a foot pedal.
